(19) United States
(12) Patent Application Publication
(10) Pub. No.: US 2010/0266308 A1
(43) Pub. Date: Oct. 21, 2010

(54) IMAGE FORMING APPARATUS AND IMAGE FORMING METHOD

(75) Inventors: Takehiro Meguro, Shizuoka (JP); Toshimi Yamashita, Kanagawa (JP); Tomoyuki Kato, Shizuoka (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/760,734

(22) Filed: Apr. 15, 2010

Related U.S. Application Data
(60) Provisional application No. 61/170,905, filed on Apr. 20, 2009.

(51) Int. Cl. G03G 21/00; G03G 15/00

(52) U.S. Cl. 399/71; 399/346

(57) ABSTRACT

An image forming apparatus configured to form an image on a transfer medium with a developer includes: an image bearing member on which an electrostatic latent image is formed, the developer is supplied to develop the electrostatic latent image, and an image to be transferred onto the transfer medium is formed, the image bearing member having surface hardness of 150 N/mm to 220 N/mm in a universal hardness value (HU); a developing device configured to supply the developer to the image bearing member; a cleaner configured to be brought into press-contact with the image bearing member at press-contact linear pressure x in a range of 16.7≦x≦22.0 [mN/mm]) and collect components of the developer remaining on the image bearing member after the image is transferred onto the transfer medium; and a lubricant containing fatty acid metal salt arranged at a distal end of the cleaner being in contact with the image bearing member, at an arrangement amount y in a range of 25≦y≦100 [ng/mm] to satisfy a condition y≧12.5x-207.5.

### CROSS-REFERENCE, TO RELATED APPLICATIONS

This application is based upon and claims the benefit of priority from the prior U.S. Patent Application No. 61/170,905 filed on Apr. 20, 2009, the entire contents of which are incorporated herein by reference.

### TECHNICAL FIELD

The present invention relates to image forming apparatuses configured to form images in an electrophotographic system such as a copying machine and a printer and an image forming method thereof.

### BACKGROUND

In an image forming apparatus of an electrophotographic system, a toner image is formed on the surface of an image bearing member and transferred onto a transfer medium such as paper. A toner remaining on the surface of the image bearing member without being transferred and other deposits are removed by a urethane blade, a nylon brush, or the like for cleaning.

Since the surface of the image bearing member is abraded by friction with the blade or the like, it is necessary to replace the image bearing member after use for a predetermined period in order to maintain functions thereof. Therefore, from the viewpoint of cost reduction, in order to realize extension of the life of the image bearing member, reduction in the abrasion of the surface of the image bearing member is examined.

JP-A-2006-53168 discloses a method of, in order to reduce abrasion of a surface layer of an image bearing member, for example, irradiating a radiation such as an electron beam on a charge transport layer (CTL) as the surface layer of the image bearing member or an overcoat layer (OCL) as an upper layer of the CTL and bridging and polymerizing the layer to harden the layer. By performing the bridging and the polymerization in the CTL or the OCL in this way, the hardness of the CTL or the OCL can be increased to 150 N/mm to 220 N/mm in a universal hardness value (HU). Therefore, it is possible to reduce the abrasion.

### SUMMARY

According to an aspect of the present invention, there is provided an image forming apparatus including: an image bearing member on which an electrostatic latent image is formed, the developer is supplied to develop the electrostatic latent image, and an image to be transferred onto the transfer medium is formed, the image bearing member having surface hardness of 150 N/mm to 220 N/mm in a universal hardness value (HU); a developing device configured to supply the developer to the image bearing member; a cleaner configured to be brought into press-contact with the image bearing member at press-contact linear pressure x in a range of 16.7≦x≦22.0 [mN/mm]) and collect components of the developer remaining on the image bearing member after the image is transferred onto the transfer medium; and a lubricant containing fatty acid metal salt arranged at a distal end of the cleaner being in contact with the image bearing member, at an arrangement amount y in a range of 25≦y≦100 [ng/mm] to satisfy a condition y≧12.5x-207.5.

According to another aspect of the present invention, there is provided an image forming method including: forming an electrostatic latent image on an image bearing member hardened to have surface hardness of 150 N/mm to 220 N/mm in a universal hardness value (HU); forming an image on the image bearing member by supplying a developer to the electrostatic latent image to develop the electrostatic latent image; bringing a cleaner into press-contact with the image bearing member at predetermined press-contact linear pressure x of 16.7 to 22.0 [mN/mm] after the image is transferred onto a transfer medium, arranging a lubricant containing fatty acid metal, salt at a distal end of the cleaner being contact with the image bearing member, at an arrangement amount y of 25 to 100 [ng/mm] to satisfy a condition y≧12.5x-207.5; and collecting components of the developer remaining on the image bearing member.

It is to be understood that both the forgoing general description and the following detailed description are exemplary and explanatory only and are not restrictive of the invention, as claimed.

### DESCRIPTION OF THE DRAWINGS

The accompanying drawings, which are incorporated in and constitute a part of this specification, illustrates an embodiment of the invention and together with the description, serve to explain the principles of the invention.

FIG. 1 is a schematic diagram of an image forming apparatus according to an embodiment of the present invention;

FIGS. 2 to 4 are enlarged views of a contact section of a cleaning blade and a photoconductive member in the embodiments;

FIG. 5 is a diagram of the distal end of the cleaning blade where a lubricant is arranged in the embodiment;

FIG. 6 is a diagram of the configuration of a quadruple tandem color printer in the embodiment;

FIG. 7 is a table of evaluation results of image deletion due to press-contact linear pressure of the cleaning blade in the embodiment;

FIG. 8 is a table of results of blade turn-up evaluation and lubricant streak evaluation in the embodiment; and

FIG. 9 is a graph of the results of the blade turn-up evaluation and the lubricant evaluation in the embodiment.

### DETAILED DESCRIPTION

Reference will now be made in detail to the present embodiment of the invention, an example of which is illustrated in the accompanying drawing.

An image forming apparatus according to an embodiment of the present invention includes: an image bearing member on which an electrostatic latent image is formed, a developer is supplied to the electrostatic latent image to develop the electrostatic latent image, and an image to be transferred onto a transfer medium is formed, the image bearing member having surface hardness of 150 N/mm to 220 N/mm in a universal hardness value (HU); a developing device configured to supply the developer to the image bearing member; a cleaner configured to be brought into press-contact with the image bearing member at press-contact linear pressure x in a range of 16.7≦x≦22.0 [mN/mm] and collect components of the developer remaining on the image bearing member after the image is transferred onto the transfer medium; and a lubricant containing fatty acid metal salt arranged at the distal end of the cleaner, which comes into contact with the image bearing member, at an arrangement amount y in a range of 25≦y≦100 [ng/mm] to satisfy a condition y≧12.5x-207.5.

As the image bearing member in this embodiment, an image bearing member having surface hardness of 150 N/mm to 220 N/mm in the universal hardness value (HU) is used. As such an image bearing member, for example, a photoconductive member such as a plus or minus charged OPC (Organic Photoconductor) having a chain polymerizable functional group is used. The image bearing member can be formed by irradiating heat, light, or a radiation such as an electron beam on a CTL or an OCL as a surface layer and bridging and polymerizing components of the layer to harden the layer.

If the surface hardness is lower than 150 N/mm in the universal hardness value (HU), when components of the developer remaining on the image bearing member after an image is transferred onto the transfer medium (a transfer residual toner) is removed by a cleaner such as a urethane blade or a nylon brush for cleaning, the surface layer of the image bearing member is shaved. On the other hand, if the surface hardness exceeds 220 N/mm in the universal hardness value (HU), since an elastic deformation amount decreases, scratches tend to occur. More desirably, the surface hardness is 160 N/mm to 200 N/mm.

However, if the surface hardness is within the range, in some case, a toner and an externally added agent for the toner present between the surface of the image bearing member and the cleaner are stretched by the friction of the image bearing member and the cleaner to cause locking. A discharge product generated by a charging device during discharge adheres to the surface of the image bearing member, whereby the surface of the image bearing member is contaminated. The adhering discharge product contains moisture under a highly humid environment to thereby have electric conductivity. Then, problems explained below occur.

When the conductive deposit is present on the surface of the image bearing member, the potential near a boundary where an electrostatic latent image is formed on the surface of the image bearing member moves. Then, the deposit raises the potential of a low potential section on the surface of the image bearing member that is an image printing section. According to the rise in the potential, the image density of the image printing section falls and image void occurs. Conversely, according to the fall in the potential in a high potential section of the surface of the image bearing member that is an image background section, an image is printed in the image background section and disordered (filming is caused). Further, chattering, a grabbing chatter, or turn-up of the cleaning blade is caused.

In order to solve these problems, it is conceivable to set the press-contact linear pressure of the cleaner (pressure obtained by converting the pressure for press contact into pressure per unit length of the cleaner) higher than usual and scrape off the deposit together with the surface layer of the image bearing member. Even if the press-contact pressure is set higher in this way, during normal printing operation, the toner and the externally added agent for the toner functioning as a lubricant between the image bearing member and the cleaner can properly keep frictional force of the image bearing member and the cleaner.

However, during the start of use, since the toner and the like are not interposed, the turn-up of the cleaner is caused by the friction of the cleaner and the image bearing member. Therefore, it is considered effective to apply the lubricant in assembling the image bearing member to a process unit of the image forming apparatus.

The turn-up of the cleaner is suppressed by using the lubricant. However, if a large amount of the lubricant is used, a state of the friction of the image bearing member and the cleaner changes and a difference occurs in charges held on the surface of the image bearing member. Then, a lubricant streak of an image bearing member pitch occurs and image unevenness occurs.

Therefore, the inventors found that, when a lubricant containing fatty acid metal salt is used as the lubricant, it is possible to scrape off the deposit on the image bearing member and suppress the turn-up and the image unevenness due to the lubricant streak by setting the press-contact linear pressure of the cleaner and the arrangement amount of the lubricant within predetermined ranges. Specifically, it is necessary to set press-contact linear pressure x of the cleaner within a range of 16.7≦x≦22.0 [mN/mm] and arrange the lubricant at the distal end of the cleaner, which comes into contact with the image bearing member, at an arrangement amount y in a range of 25≦y≦100 [ng/mm] to satisfy a condition y≧12.5x-207.5.

If the press-contact linear pressure is lower than 16.7 [mN/mm], the deposit on the image bearing member cannot be sufficiently scraped off. If the press-contact linear pressure exceeds 22.0 [mN/mm], it is highly likely that the turn-up of the cleaner occurs irrespectively of an amount of the lubricant. If the arrangement amount of the lubricant is smaller than 25 [ng/mm], the turn-up occurs even when the press-contact linear pressure is within the specified range. If the arrangement amount exceeds 100 [ng/mm], the image unevenness due to the lubricant streak occurs. If a relation between the press-contact linear pressure x and the lubricant arrangement amount y is y<12.5x-207.5, even if the press-contact linear pressure and the arrangement amount are within the specified ranges, the turn-up of the cleaner occurs.

As the lubricant containing fatty acid metal salt, zinc stearate, magnesium stearate, calcium stearate, or the like can be used. An average particle diameter of these substances is desirable 0.02 μm to 2.0 μm. If the average particle diameter is smaller than 0.02 μm, since the cleaning blade cannot scrape off the deposit and the lubricant cannot be held on the ridge of the blade, lubricant insufficiency occurs. On the other hand, if the average particle diameter exceeds 2.0 μm, since the lubricant cannot be uniformly arranged at a fine particle diameter on the ridge of the cleaning blade, local lubricant insufficiency occurs.

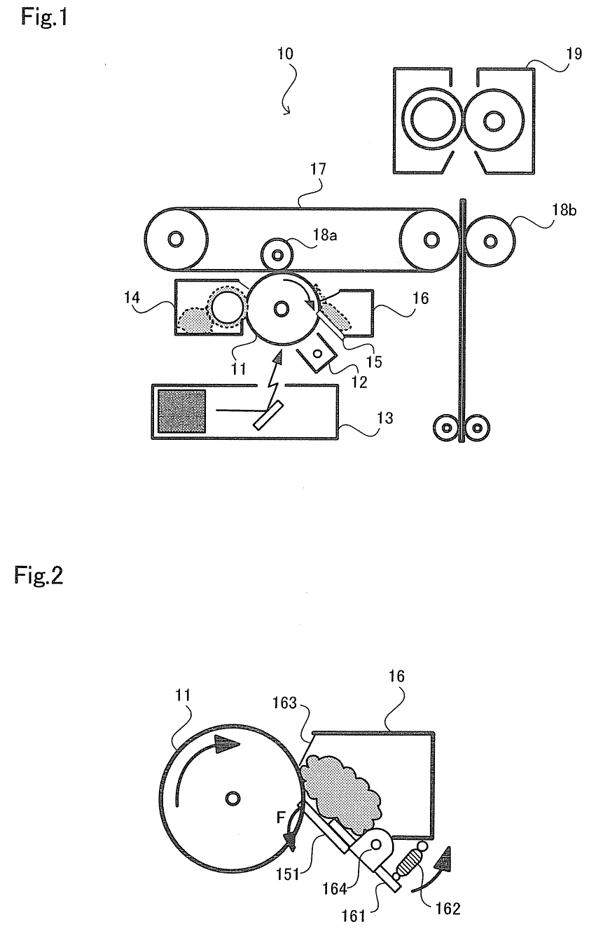

A schematic diagram of the image forming apparatus in which the press-contact linear pressure of the cleaner and the arrangement'amount of the lubricant containing fatty acid metal salt are set within the predetermined ranges as explained above is shown in FIG. 1. An image forming apparatus 10 includes a photoconductive member 11 as an image bearing member, a charging device 12 configured to charge the photoconductive member 11, an exposing device 13 for forming an electrostatic latent image on the photoconductive member 11, a developing device 14 including a developing roller for supplying a developer onto the photoconductive member 11 to develop the electrostatic latent image, a cleaner unit 16 including a cleaner 15 such as a urethane blade or a nylon blade for removing and collecting a transfer residual toner, a primary transfer roller 18a for transferring an image on the photoconductive member 11 onto an intermediate transfer belt 17, a secondary transfer roller 18b for transferring the image onto a transfer medium P, and a fixing device 19 for fixing the transferred image on the transfer medium P.

An image is formed on the transfer medium P according to a process explained below by using such an image forming apparatus.

The photoconductive member 11 is uniformly charged at desired potential by a publicly-known charging device 12 such as a charge wire, a comb-tooth shaped charger, a corona charger such as scorotron, a contact charging roller, a non-contact charging roller, a solid charger, or a contact charging brush. Further, an electrostatic latent image is formed on the photoconductive member 11 according to image information by exposing the photoconductive member 11 to light with the exposing device 13 employing publicly-known means such as a laser or an LED.

The developer supplied to the developing device 14 is conveyed to the developing roller including a mug roller. Charged toner particles are supplied to and deposited on the electrostatic latent image on the photoconductive member 11 by a magnetic brush phenomenon, whereby the electrostatic latent image is developed and an image is formed. DC development bias or development bias obtained by superimposing AC on DC is applied to the developing roller in order to form an electric field for uniformly and stably depositing the toner particles.

Transfer voltage is applied to the formed image by the primary transfer roller 18a and the secondary transfer roller 18b arranged in contact with the photoconductive member 11. The image is transferred onto the transfer medium P such as paper. The transfer medium P having the image transferred thereon is peeled off from the photoconductive member 11 and conveyed to the fixing device 19. The image is fixed on the transfer medium P by publicly-known heating; pressing, and fixing means such as a heat roller. A transfer residual toner remaining on the photoconductive member 11 without being transferred after the image is transferred is removed and collected by the cleaner 15.

As the cleaner, a cleaning blade can be used. The cleaning blade is brought into press-contact with the surface of the photoconductive member to remove a deposit. Such a cleaning blade is formed of an elastic member containing, as a main component, diene rubber such as butadiene rubber or isopropylene rubber or polyurethane rubber. The cleaning blade is bonded to or insert-molded to be fixed to a holding sheet metal and brought into press-contact with the photoconductive member at predetermined press-contact linear pressure.

As shown in FIG. 2 as an enlarged view of a contact section of the cleaning blade and the photoconductive member, a cleaning blade 151 bonded to a holding sheet metal 161 can be brought into press-contact with the photoconductive member 11 at predetermined press-contact linear pressure F by controlling a pressing spring 162. Reference numeral 163 denotes a recovery seal and 164 denotes a blade rotation fulcrum.

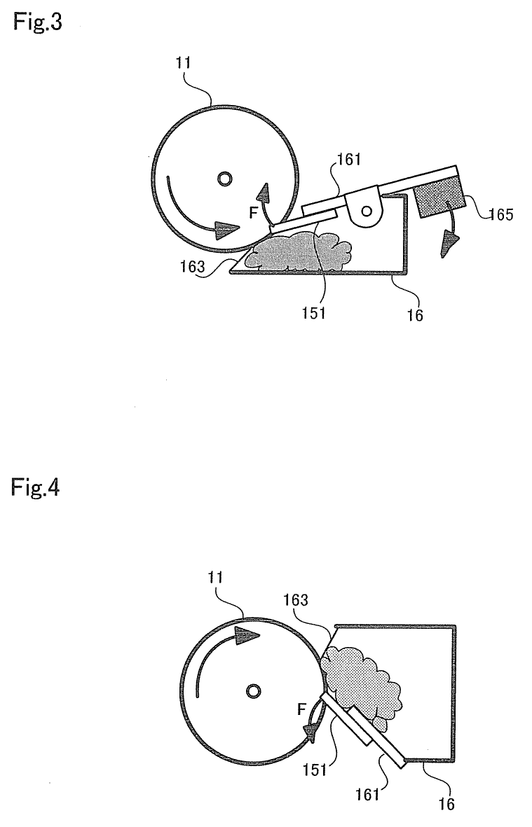

As shown in FIG. 3, the cleaning blade 151 can be brought into press-contact with the photoconductive member 11 at the predetermined press-contact linear pressure F by attaching a pressing weight 165 to the rear end of the holding sheet metal 161 to which the cleaning blade 151 is bonded.

As shown in FIG. 4, the position of the distal end of the cleaning blade 151 connected to the holding sheet metal 161 can be arranged to bite into the photoconductive member 11 such that the cleaning blade 151 is brought into press-contact with the photoconductive member 11 at the predetermined press-contact linear pressure F. In this case, it is possible to obtain the predetermined press-contact linear pressure without providing the pressing spring, the pressing weight, or the like.

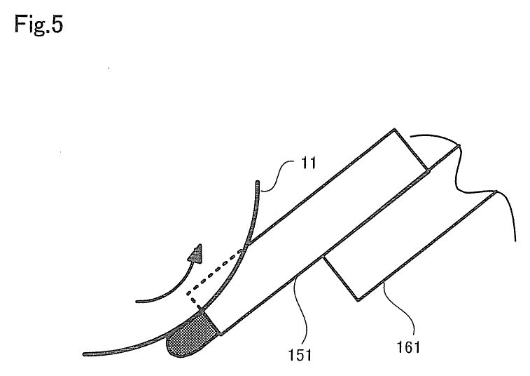

In this way, the cleaner 15 is brought into press-contact with the photoconductive member 11 at the predetermined press-contact linear pressure. As shown in FIG. 5, a lubricant 164 containing fatty acid metal salt is arranged at a predetermined amount at the distal end of the cleaning blade 151 connected to the holding sheet metal 161. A method of arranging the lubricant is not specifically limited.

For example, the predetermined amount of the lubricant can be arranged on the entire surface or a part of the surface of the photoconductive member 11 by patting with a cotton bag in which the lubricant is encapsulated or applying the lubricant to the surface in a powder state using a brush or the like. Alternatively, the predetermined amount of the lubricant may be fixed to the surface of the photoconductive member 11 by, after mixing and dispersing the lubricant in a solvent such as an organic solvent and applying the lubricant, vaporizing the solvent. An application amount Y [ng/mm²] per unit area of the lubricant applied to the surface of the photoconductive member can be represented as Y=0.01y with respect to the arrangement amount y [ng/mm] per unit length.

As the lubricant, besides the fatty acid metal salt, alkylenebisstearylamide such as ethylenebisstearylamide or isobutylenebisstearylamide, polymethacrylate acid ester such as polymethylmethacrylate (PMMA), polytetrafluoroethylene (PTFE), polyvinylidene fluoride(PVDF), or the like can be used. When these substances are used, a necessary arrangement amount g/mm (application amount g/mm²) thereof is about 10⁴ times as large as that of the fatty acid metal salt.

In this way, the press-contact linear pressure of the cleaner on the image bearing member and the arrangement amount of the lubricant are set to the predetermined values. Consequently, in the image forming apparatus, it is possible to scrape off the deposit on the image bearing member and suppress the turn-up and the image unevenness due to the lubricant streak.

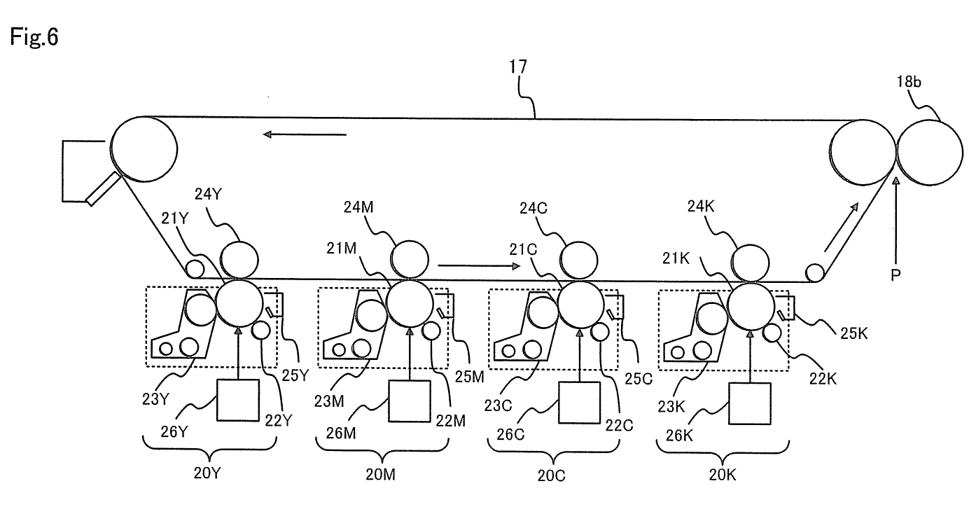

Such a configuration can also be applied to a quadruple tandem color printer shown in FIG. 6. As shown in FIG. 6, the secondary transfer roller 18b for transferring an image on the intermediate transfer belt 17 onto the transfer medium P and image forming units 20_{Y}, 20_{M}, 20_{C}, and 20_{K} are arranged along a conveying direction of the intermediate transfer belt 17 (an arrow direction).

The image forming units 20_{Y}, 20_{M}, 20_{C}, and 20_{K} include photoconductive members 21_{Y}, 21_{M}, 21_{C}, and 21_{K} as image bearing members. The color printer further includes, around respective photoconductive drums, chargers 22_{Y}, 22_{M}, 22_{C}, and 22_{K} as charging means, developing devices 23_{Y}, 23_{M}, 23_{C}, and 23_{K} having developing rollers as developing members and the like and respectively having stored therein developers respectively including color toner particles of yellow, magenta, cyan, and black and carrier particles, primary transfer rollers 24_{Y}, 24_{M}, 24_{C}, and 24_{K} as transfer means, and cleaner units 25_{W}, 25_{M}, 25_{C}, and 25_{K}. These devices are respectively arranged along rotating directions of the photoconductive members 21_{Y}, 21_{M}, 21_{C}, and 21_{K} corresponding thereto.

The primary transfer rollers 24_{Y}, 24_{M}, 24_{C}, and 24_{K} are disposed on the inner side of the intermediate transfer belt 10. The intermediate transfer belt 10 is nipped between the primary transfer rollers 24_{Y}, 24_{M}, 24_{C}, and 24_{K} and the photoconductive drums 21_{Y}, 21_{M}, 21_{C}, and 21_{K} corresponding thereto. Exposing devices 26_{Y}, 26_{M}, 26_{C}, and 26_{K} are arranged such that exposure points are respectively formed on outer circumferential surfaces of the photoconductive members 21_{Y}, 21_{M}, 21_{C}, and 21_{K} between the chargers 22_{Y}, 22_{M}, 22_{C}, and 22_{K} and the developing devices 23_{Y}, 23_{M}, 23_{C}, and 23_{K}. The secondary transfer roller 18b is arranged on the outer side of the intermediate transfer belt 17 to be set in contact with the intermediate transfer belt 17.

In the image forming apparatus configured as explained above, first, a toner image is formed by the image forming unit 20_{Y}. The same process is performed in the image forming units 20_{M}, 20_{C}, and 20_{K} at timing of the toner image formation in the image forming unit 20_{Y}. Magenta, cyan, and black toner images formed on the photoconductive members of the image forming units 20_{M}, 20_{C}, and 20_{K} are sequentially primarily transferred onto the intermediate transfer belt 17.

The transfer medium P is conveyed from a cassette (not shown) and forwarded to the intermediate transfer belt 17 by an aligning roller (not shown) to be timed to coincide with the toner images on the intermediate transfer belt 17.

Bias (+) having polarity opposite to charging polarity of toners is applied to the secondary transfer rollers 18b by a power supply (not shown). As a result, the toner images on the intermediate transfer belt 17 are transferred onto the transfer medium P by a transfer electric field formed between the intermediate transfer belt 17 and the secondary transfer roller 18b. A fixing device (not shown) for fixing the toners transferred onto the transfer medium P is disposed. A fixed image is obtained by causing the transfer medium P to pass through the fixing device.

In the example explained above, the image forming units are arranged in order of the colors yellow, magenta, cyan, and black. However, this color order is not specifically limited.

### Example 1

The image forming apparatus shown in FIG. 1 was used. Hardness of the surface of the photoconductive member (hereinafter referred to as photoconductive member hardness) was set to 150 N/mm to 220 N/mm. The press-contact linear pressure of the cleaning blade (hereinafter referred to as blade linear pressure) and an initial arrangement amount of the lubricant (an arrangement amount during the start of use of the image forming apparatus) were fluctuated and evaluation was performed as explained below.

### Image Deletion Evaluation

A process unit in which the press-contact linear pressure of the cleaning blade on the photoconductive member was changed to a desired value was used. In a low humidity environment, printing was applied to normal copy sheets by a specified number of sheets for the photoconductive member or a predetermined number of sheets.

Image deletion occurs because charges on the surface of the photoconductive member cannot be held and move to other sections because of a deposit that cannot be cleaned on the photoconductive member because of low press-contact linear pressure. Specifically, the image deletion is a phenomenon in which a printing section flows to a non-printing section in a circumferential direction of the photoconductive member and a background section as the non-printing section flows into the printing section.

Image deletion was evaluated by checking printing of the process unit after printing in a high humidity environment. When occurrence of the image deletion phenomenon was not observed, an evaluation result is represented as A. When occurrence of the image deletion phenomenon was observed, an evaluation result is represented as B.

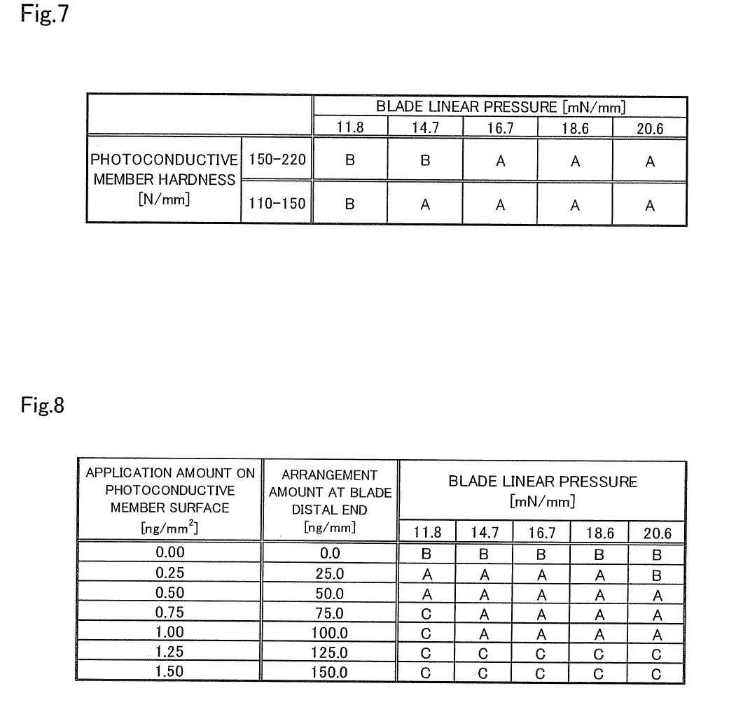

Image deletion evaluation results due to the press-contact linear pressure of the cleaning blade are shown in FIG. 7. As shown in FIG. 7, it is seen that image deletion is not observed when the blade linear pressure is equal to or higher than 16.7 [mN/mm]. As a comparative example, a result obtained by evaluating image deletion in the same manner when the photoconductive member hardness is equal to or higher than 110 N/mm and lower than 150 N/mm is shown. It is seen that, even if the blade linear pressure is 14.7 mN/mm, image deletion does not occur and, when the photoconductive member hardness increases, the blade linear pressure needs to be raised.

### Blade Turn-Up Evaluation

The process unit in which the press-contact linear pressure of the cleaning blade on the photoconductive member was changed to the desired value was used. A predetermined amount of the lubricant was applied to the surface of the photoconductive member or arranged at the distal end of the cleaning blade. In a high humidity environment, printing of a predetermined number of sheets was repeated a predetermined number of times. A printing ratio for an image at this point was set to 0%. Since the toner also had an effect of the lubricant, the toner was not circulated to the cleaning blade.

Blade turn-up was evaluated according to presence or absence of occurrence of turn-up of the cleaning blade after printing.

### Lubricant Streak Evaluation

The process unit in which the press-contact linear pressure of the cleaning blade on the photoconductive member was changed to the desired value was used. A predetermined amount of the lubricant was applied to the surface of the photoconductive member or arranged at the distal end of the cleaning blade. The photoconductive member was idly rotated in a normal temperature and normal humidity environment and thereafter a halftone images was sampled.

A lubricant streak was evaluated according to presence or absence of occurrence of streak-like image abnormality in the halftone image.

Both results of the blade turn-up evaluation and the lubricant streak evaluation are shown in FIG. 8. When neither turn-up nor a lubricant streak was observed, an evaluation result is represented as A. When turn-up was observed, an evaluation result is represented as B. When a lubricant streak was observed, an evaluation result is represented as C.

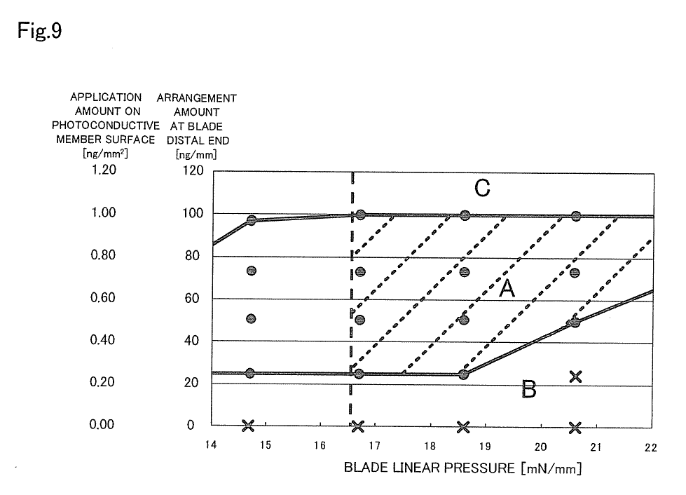

Results obtained by plotting a lubricant arrangement amount (application amount) on the ordinate and plotting blade linear pressure on the abscissa are shown in FIG. 9. With respect to areas where the blade linear pressure was equal or larger than 16.7 [mN/mm] and image deletion was not observed, an area where neither turn-up nor a lubricant streak was observed is represented as A, an area where turn-up was observed is represented as B, and an area where a lubricant streak was observed is represented as C.

As shown in FIGS. 8 and 9, it is seen that, when press-contact linear pressure x of the cleaner is set in a range of 16.75≦x≦22.0 [mN/mm] and an arrangement amount y of the lubricant is set in a range of 25y≦100 [ng/mm] to satisfy a condition y≧12.5x-207.5, turn-up and a lubricant streak are not observed and a satisfactory state can be obtained.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An image forming apparatus configured to form an image on a transfer medium with a developer, the image forming apparatus comprising:
an image bearing member on which an electrostatic latent image is formed, the developer is supplied to develop the electrostatic latent image, and an image to be transferred onto the transfer medium is formed, the image bearing member having surface hardness of 150 N/mm to 220 N/mm in a universal hardness value (HU);
a developing device configured to supply the developer to the image bearing member;
a cleaner configured to be brought into press-contact with the image bearing member at press-contact linear pressure x in a range of 16.7×22.0 [mN/mm]) and collect components of the developer remaining on the image bearing member after the image is transferred onto the transfer medium; and
a lubricant containing fatty acid metal salt arranged at a distal end of the cleaner being in contact with the image bearing member, at an arrangement amount y in a range of 25≦y≦100 [ng/mm] to satisfy a condition y≧12.5x-207.5.

2. The apparatus according to claim 1, wherein the lubricant is applied to a surface of the image bearing member.

3. The apparatus according to claim 2, wherein an application amount Y [ng/mm²] of the lubricant is represented as Y=0.01y.

4. The apparatus according to claim 1, wherein the lubricant is zinc stearate.

5. The apparatus according to claim 1, wherein the image bearing member includes a charge transport layer on a surface of the image bearing member.

6. The apparatus according to claim 1, wherein the image bearing member includes an overcoat layer provided on a charge transport layer on a surface of the image bearing member.

7. The apparatus according to claim 1, further comprising a pressing mechanism configured to control press-contact linear pressure of the cleaner.

8. The apparatus according to claim 7, wherein the pressing mechanism includes a pressing spring.

9. The apparatus according to claim 7, wherein the pressing mechanism includes a pressing weight.

10. The apparatus according to claim 1, further comprising a non-contact charging device.

11. An image forming method comprising:
forming an electrostatic latent image on an image bearing member hardened to have surface hardness of 150 N/mm to 220 N/mm in a universal hardness value (HU);
forming an image on the image bearing member by supplying a developer to the electrostatic latent image to develop the electrostatic latent image;
bringing a cleaner into press-contact with the image bearing member at predetermined press-contact linear pressure x of 16.7 to 22.0 [mN/mm] after the image is transferred onto a transfer medium, arranging a lubricant containing fatty acid metal salt at a distal end of the cleaner being contact with the image bearing member, at an arrangement amount y of 25 to 100 [ng/mm] to satisfy a condition y≧12.5x-207.5; and
collecting components of the developer remaining on the image bearing member.

12. The method according to claim 11, wherein the lubricant is applied to a surface of the image bearing member.

13. The method according to claim 12, wherein the lubricant is applied to the surface of the image bearing member in a powder state.

14. The method according to claim 12, wherein
the lubricant is applied to the surface of the image bearing member in a state in which the lubricant is dispersed in a solvent, and
the lubricant is fixed by vaporizing the solvent.

15. The method according to claim 12, wherein an application amount Y [ng/mm²] of the lubricant is represented as Y=0.01y.

16. The method according to claim 11, wherein the lubricant is zinc stearate.

17. The method according to claim 11, wherein a surface of the image bearing member is hardened by being bridged and polymerized by irradiation of a radiation.

18. The method according to claim 17, wherein the surface of the image bearing member is a charge transport layer.

19. The method according to claim 17, wherein the surface of the image bearing member is an overcoat layer provided on the charge transport layer.

20. The method according to claim 11, further comprising controlling press-contact pressure of the cleaner with a pressing mechanism.
